(19) United States
(12) Patent Application Publication
(10) Pub. No.: US 2011/0299703 A1
(43) Pub. Date: Dec. 8, 2011

(54) MINIATURE TRANSDUCER ASSEMBLY WITH INTEGRATED DE-COUPLING COILS

(75) Inventors: Petteri Annamaa, Oulunsalo (FI); Petri Huhtalo, Tupos (FI); Matti Niemi, Arkkukari (FI); Aki Lamponen, Kempele (FI); Yasser Amin, Tilst (DK); Morten Kjeldsen Andersen, Odder (DK)

(73) Assignee: Gettop Europe R&D ApS, Herlve (DE)

(21) Appl. No.: 13/132,192

(22) PCT Filed: Dec. 3, 2009
(86) PCT No.: PCT/EP2009/066331

§ 371 Date: Aug. 26, 2011

Related U.S. Application Data
(60) Provisional application No. 61/201,120, filed on Dec. 5, 2008.

(51) Int. Cl. H04R 13/00; H04R 13/02

(52) U.S. Cl. 381/94.1

(57) ABSTRACT

The present invention relates to a miniature transducer assembly for a wireless portable terminal. The miniature transducer assembly of the present invention comprises a transducer unit comprising a number of voice coils for displacing a diaphragm of said transducer unit. Moreover, the transducer assembly comprises at least one de-coupling coil for avoiding interference between the transducer unit and an antenna of the wireless portable terminal. In order to reduce the dimensions of the transducer assembly at least one de-coupling coil forms an integral part of a lead-out wire from of a voice coil.

### FIELD OF THE INVENTION

The present invention relates to a miniature transducer assembly for a wireless portable terminal. In particular, the present invention relates to a miniature transducer assembly comprising a transducer unit including a number of voice coils having lead-out wires associated thereto. In order to reduce the dimensions of the transducer assembly at least one de-coupling coil forms an integral part of a lead-out wire from the voice coil.

### BACKGROUND OF THE INVENTION

Various prior art references relate to speaker devices for wireless portable terminals, and more particularly, to speaker devices configured to prevent emitted resonant frequencies from degrading antenna radiation in a wireless portable terminal, such as a mobile phone, when such speaker devices are installed in the vicinity of an antenna device. An example of such prior art is EP 1 703 585.

EP 1 703 585 relates to a speaker device where a pair of inductors forming a pair of so-called de-coupling coils are interposed at the input and output portions of a voice coil. The inductors are serially connected to the voice coil, thereby avoiding resonance in a radio frequency (RF) band. The inductors are so configured as to have an appropriate inductance according to the output power and impedance of the speaker. The number and positions of the inductors may vary depending on coupling between the speaker device and the antenna device during a speaker operation. EP 1 703 585 discloses that the inductors may be provided at a “feeding portion” of the voice coil or they may be provided on the diaphragm of the speaker. FIG. 2 of EP 1 703 585 shows an embodiment where the inductors are provided on the diaphragm, whereas FIG. 3 shows an embodiment where the inductors are provided at the so-called feeding portion of the voice coil. From paragraph [0021] of the description of EP 1 703 585 it is evident that the feeding portion is external to the speaker device.

It may be seen as an object of embodiments of the present invention to provide a miniature transducer assembly with at least one integrated de-coupling coil so as to provide a compact transducer assembly.

### DESCRIPTION THE INVENTION

It has been found by the present inventors that by integrating de-coupling coils with lead-out wires from a voice coil the costs of manufacturing of miniature transducer assemblies can be decreased. In addition, the reliability and reproducibility of miniature transducer assemblies can be significantly improved. Moreover, miniature transducer assemblies may be made more compact which results in an improved performance.

In a first aspect the present invention relates to a miniature transducer assembly for a wireless portable terminal, the miniature transducer assembly comprising a transducer unit comprising a number of voice coils for displacing a diaphragm of said transducer unit, the transducer assembly further comprising at least one de-coupling coil for avoiding interference between the transducer unit and an antenna of said wireless portable terminal, wherein at least one de-coupling coil forms an integral part of a lead-out wire of a voice coil.

Thus, a miniature transducer assembly with at least one integrated de-coupling coil is provided so as to prevent that emitted resonance frequencies degrade antenna radiation in a wireless portable terminal, such as a mobile phone.

The term “miniature” means that the transducer assembly has dimensions in the millimetre range. Typical dimensions (length×width×height) are around 15×11×3 mm. However, it should be understood that the dimensions may differ from these dimensions without departing from the scope of protection of the present invention.

Preferably, the at least one de-coupling coil is connected in series with the voice coil. This is preferably accomplished by providing a voice coil having lead-out wires being so long that de-coupling coils may be formed by wrapping these lead-out wires around a suitable object provided in connection with the miniature transducer assembly. Alternatively, a de-coupling coil may be formed by a pre-wrapped air coil being fitted onto the before-mentioned object, or alternatively fitted into a cavity (hole) inside the assembly. Preferably, the suitable object or objects may be provided in connection with an external housing or support at least partly encapsulating the transducer unit and the at least one de-coupling coil.

Preferably, the transducer unit comprises a magnetic circuit for generating magnetic flux in a number of air gaps. A number of voice coils for displacing the diaphragm of the transducer unit is/are at least partly positioned in the air gap(s). The voice coil or coils is/are attached to the diaphragm of the transducer unit so that forces acting on the voice coil or coils are transferred to the diaphragm which causes the diaphragm to be displaced. It should be understood that the actual design and implementation of the transducer unit may vary without departing from the scope of the invention.

The at least one de-coupling coil may be arranged externally or internally relative to the transducer unit. Thus, the at least one de-coupling coil may be positioned either outside or inside the transducer unit.

Typically, the transducer unit comprises a single voice coil and first and second lead-out wires associated therewith. The first and second lead-out wires may be constituted by the same wire forming the single voice coil. The lead-out wires may be formed by a variety of types of wire, such a CU wire or a Copper Clad Aluminum (CCA) wire.

First and second de-coupling coils may form integral parts of the respective ones of the first and second lead-out wires. In this manner a single and unbroken wire forms a series connection of two de-coupling coils and a voice coil. As previously mentioned the voice coil is attached to the diaphragm.

The de-coupling coil(s) may have an inductance within the range 20-100 nH, such as within the range 30-90 nH, such as within the range 40-80 nH, such as within the range 50-70 nH, such as approximately 60 nH.

The voice coil may have an impedance of 4-16 ohm, such as 8 ohm.

The miniature transducer assembly may further comprise an exterior housing at least partly encapsulating the transducer unit and the at least one de-coupling coil. The exterior housing may be provided with an inwardly directed object or objects around which the de-coupling coils may be wound. In case of pre-wrapped air coils these coils may be positioned around said object or objects during assembling of the assembly.

In a second aspect the present invention relates to a de-coupling coil for preventing the emitting of resonant frequencies from degrading antenna radiation in a wireless portable terminal, the de-coupling coil being formed as an integral part of a lead-out wire from a voice coil of a miniature transducer unit. The de-coupling coil according to the second aspect may be of the kind used with the miniature transducer assembly according to the first aspect.

In a third aspect, the present invention relates to a method for manufacturing a coil assembly, the method comprising the steps of
forming a voice coil from a piece of electrically conductive wire, said voice coil comprising a first and second lead-out wires, and
forming a first de-coupling coil by coiling or wrapping the first lead-out wire a predetermined number of times.

The method may further comprise the step of forming a second de-coupling coil by coiling or wrapping the second lead-out wire a predetermined number of times.

As previously mentioned the de-coupling coil(s) may have an inductance within the range 20-100 nH, such as within the range 30-90 nH, such as within the range 40-80 nH, such as within the range 50-70 nH, such as approximately 60 nH. The number of turns for each de-coupling coil is typically between 4 and 10. The voice coil may have an impedance of 4-16 ohm, such as 8 ohm.

In a fourth aspect the present invention relates to a miniature transducer assembly for a wireless portable terminal, the miniature transducer assembly comprising a transducer unit comprising a number of voice coils for displacing a diaphragm of said transducer unit, the transducer unit further comprising at least one de-coupling coil for avoiding interference between the transducer unit and an antenna of said wireless portable terminal, wherein the at least one de-coupling coil of said transducer unit is/are positioning inside said transducer unit, and wherein at least one de-coupling coil form(s) an integral part of a lead-out wire of a voice coil.

According to the fourth embodiment of the present invention the at least one de-coupling coil is/are positioning inside said transducer unit. The term “inside” should be understood broadly as it will be explained in the following. For example, if the at least one de-coupling coil is/are positioned within a transducer housing that at least partly encapsulates the transducer unit then the at least one de-coupling coil may be considered as being positioned inside the transducer unit. Moreover, or in combination therewith, the at least one de-coupling coil may be considered as being positioned inside the transducer unit if said at least one de-coupling coil is/are positioned below a diaphragm of said transducer unit.

Since the transducer assembly is to applied in a wireless portable terminal, such as a mobile phone, with limited space available it is a valuable feature of this particular embodiment of the present invention that the at least one de-coupling coil is/are positioned inside the transducer unit whereby valuable space is saved.

As already mentioned the at least one de-coupling coil may be positioned below a moveable diaphragm of said transducer assembly.

Similar to the previous embodiments of the present invention the transducer unit may comprise a single voice coil and first and second lead-out wires associated therewith. The first and second de-coupling coils may form integral parts of the first and second lead-out wires, respectively. The at least one de-coupling coil may be manufactured in a pre-wrapping process following the manufacturing of the voice coil.

The de-coupling coil(s) may have an inductance within the range 20-100 nH, such as within the range 30-90 nH, such as within the range 40-80 nH, such as within the range 50-70 nH, such as approximately 60 nH.

In a fifth aspect the present invention relates to a wireless portable terminal comprising a miniature transducer assembly according to the first or the fourth aspects of the present invention. In a sixth and final aspect the present invention relates to a mobile phone comprising a miniature transducer assembly according to the first or the fourth aspects of the present invention.

### LEGENDS TO THE DRAWINGS

The present invention will now be described in further details with reference to the accompanying figures where

FIG. 1 shows a voice coil with de-coupling coils integrated with the lead-out wires,

FIG. 2 shows a transducer unit with internal de-coupling coils,

FIG. 3 shows a transducer unit with external de-coupling coils,

FIG. 4 shows part of a miniature transducer assembly,

FIG. 5 shows a transducer unit forming part of an audio module, where the transducer unit is equipped with internal de-coupling coils,

FIG. 6 shows a close-up view of the transducer unit shown in FIG. 5, and

FIG. 7 shows the transducer unit of FIGS. 5 and 6 with a diaphragm.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DISCLOSURE OF THE DRAWINGS

In one embodiment of the assembly according to the present invention the miniature transducer unit involves a magnetic circuit being constituted by an outer pole piece, a permanent magnet and an inner pole piece arranged on top of the permanent magnet. The inner pole piece and outer parts of the outer pole piece form an air gap into which a voice coil is at least partly positioned. The voice coil is attached to a displaceable diaphragm which is secured to an outer frame structure via a suspension member.

The assembly may be sandwiched between a front plate and a support plate of for example a mobile phone—the support plate optionally supporting contact terminals for electrically connecting the voice coil to external drive circuits.

It should be noted that the miniature transducer unit may be susceptible to various modifications and alternative forms. Thus, the number of diaphragms, magnets, voice coils, pole pieces etc. may differ.

The voice coil is implemented as an electrically conductive wire being wounded and shaped in a particular shape in order to match the shape of the air gap of the magnetic circuit. In principle the voice coil may take any shape, such as circular, rectangular etc.

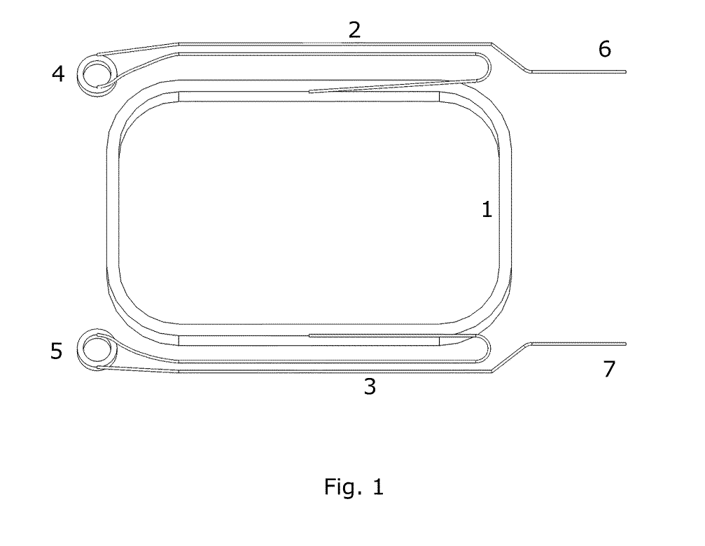

Referring now to FIG. 1 a voice coil 1 having two lead-out wires 2, 3 is depicted. As seen a pair of de-coupling coils 4, 5 are integrated with respective ones of said lead-out wires. It has been found by the inventors that de-coupling coils having an inductance around 60 nH can prevent emitted resonant frequencies from degrading antenna radiation in mobile phones. Each of the de-coupling coils typically contains between 4 and 10 windings. The diameter of a typical de-coupling coil is approximately 1 mm.

Thus, by following the principle of the present invention a series connection involving two de-coupling coils and a voice coil is established using a single and unbroken wire. Moreover, the wire ends 6, 7 of the same wire may be attached to suitable contact pads in order to connect the de-coupling coils and the voice coil to external drive electronics, such as an appropriate amplifier.

As previously stated the voice coil 1 is adapted to be attached to a diaphragm (not shown). The voice coil may have an impedance of 4-16 ohm, preferably 8 ohm.

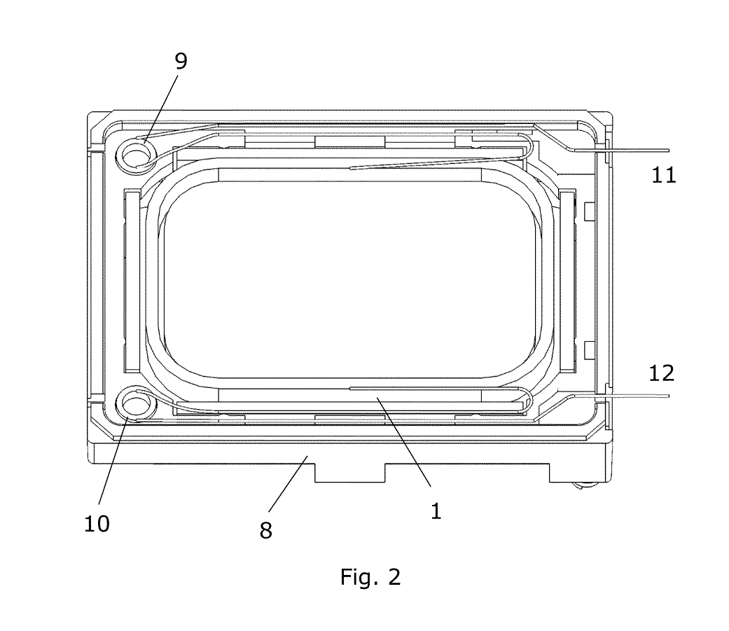

Referring now to FIG. 2 the voice coil/de-coupling coil arrangement of FIG. 1 is positioned in a transducer unit housing 8. In this embodiment of the present invention the de-coupling coils 9, 10 are positioned within the housing 8 to which a diaphragm (not shown) is attached. Thus, when the diaphragm is attached to the housing 8, the de-coupling coils 9, 10 are positioned below the diaphragm. The wire ends 11, 12 are externally accessible and adapted to be attached to suitable contact pads in order to connect the voice coil/de-coupling coil arrangement to external drive electronics, such as an appropriate amplifier.

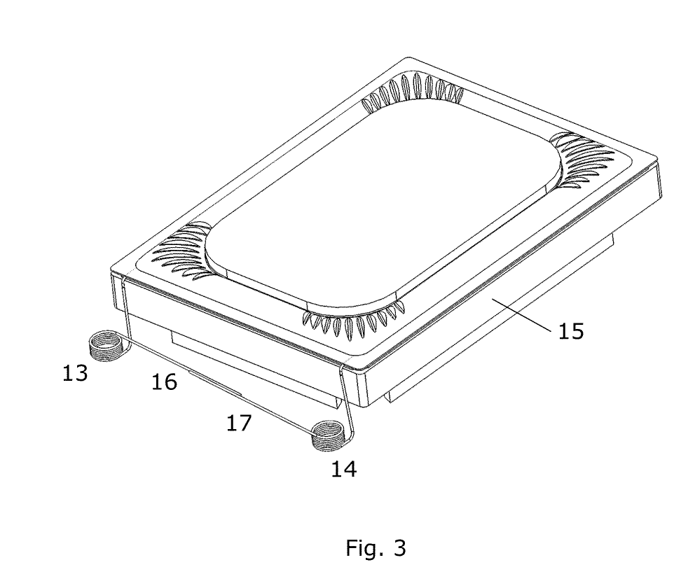

Another embodiment of the present invention is depicted in FIG. 3 where the de-coupling coils 13, 14 are arranged externally relative to the transducer unit housing 15. Again, the wire ends 16, 17 are adapted to be attached to suitable contact pads in order to connect the voice coil/de-coupling coil arrangement to external drive electronics, such as an appropriate amplifier.

The de-coupling coils illustrated in FIGS. 1-3 are all manufactured as a part of a pre-wrapping process where, in a first step, the voice coil is wrapped and where, in a second step, the de-coupling coils are wrapped. The pre-wrapped voice coil and associated de-coupling coils are then arranged with the transducer unit as depicted in the embodiments of FIGS. 2 and 3.

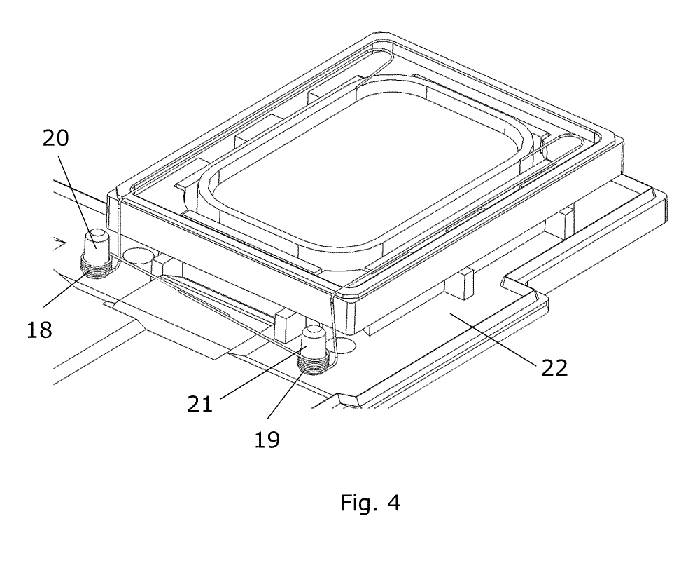

In FIG. 4 a transducer unit with externally arranged de-coupling coils 18, 19 are depicted. The transducer unit and the de-coupling coils are arranged on a support structures 22 having objects 20, 21 for holding the de-coupling coils 18, 19 integrated wherewith or attached thereto. The support structure 22 may be a common carrier arranged within for example a mobile phone, said common carrier also being adapted to hold PCB's, displays units, antenna etc.

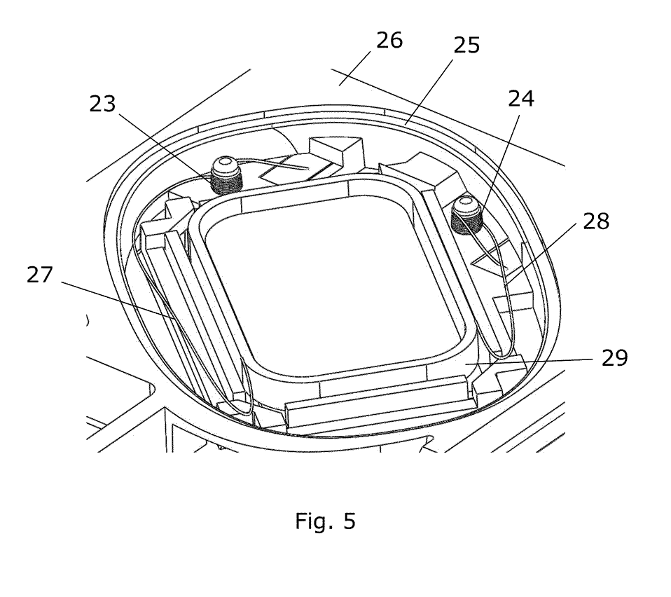

FIG. 5 shows another embodiment of the present invention where the de-coupling coils 23, 24 are positioned inside a transducer unit. In the embodiment depicted in FIG. 5 a diaphragm (not shown) is to be secured to the peripheral edge 25 of the transducer housing 26. Thus, when the transducer unit is assembled the de-coupling coils 23, 24 are positioned below the diaphragm (not shown). Similar to the previous embodiments of the present invention the de-coupling coils 23, 24 form an integral part of the lead-out wires 27, 28 from the voice coil 29 which is secured to the diaphragm in the assembled state of the transducer unit.

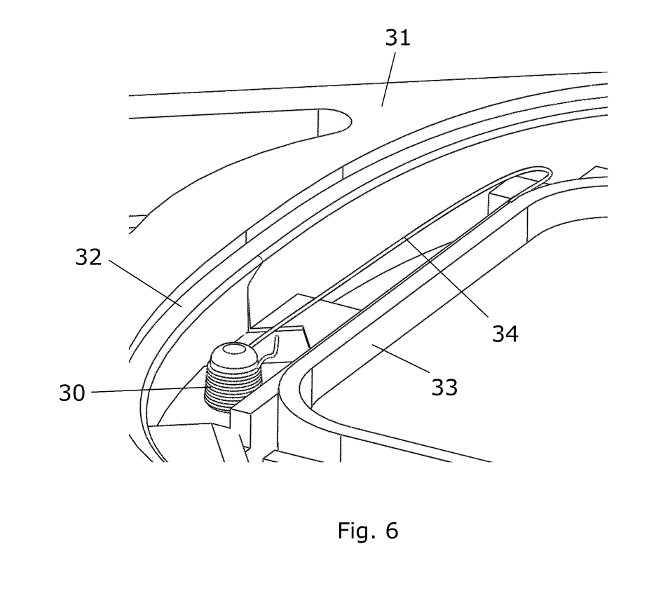

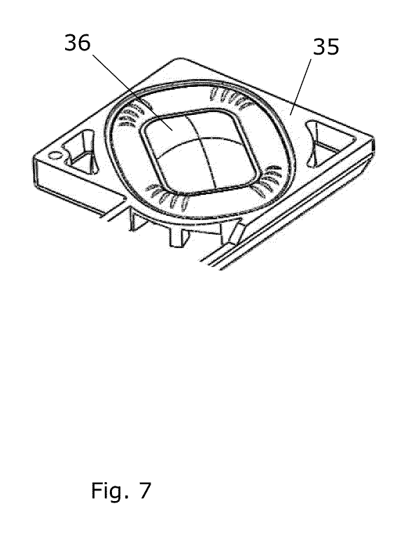

FIG. 6 shows a close-up view of one internal de-coupling coil 30 of the embodiment shown in FIG. 5. Again the transducer housing 31, the peripheral edge 32 to which the diaphragm (not shown) is to be secured, the voice coil 33 and an associated lead-out wire 34 is depicted. FIG. 7 shows a transducer unit with a diaphragm 36 being secured to a transducer housing 35. The de-coupling coils integrated with the lead-out wires from the voice coil are hidden below the diaphragm 36.

Each of these embodiments and obvious variations thereof is contemplated as falling within the spirit and scope of the claimed invention, which is set forth in the following claims.

1. A miniature transducer assembly for a wireless portable terminal, the miniature transducer assembly comprising a transducer unit comprising a voice coil for displacing a diaphragm of said transducer unit, the transducer unit further comprising a de-coupling coil for avoiding interference between the transducer unit and an antenna of said wireless portable terminal, wherein the de coupling coil of said transducer unit is positioned inside said transducer unit, and wherein the de-coupling coil forms an integral part of a lead-out wire of the voice coil.

2. The miniature transducer assembly according to claim 1, wherein the de-coupling coil is positioned below a moveable diaphragm of said transducer assembly.

3. The miniature transducer assembly according to claim 1, wherein the transducer unit comprises a single voice coil and first and second lead-out wires associated therewith.

4. The miniature transducer assembly according to claim 3, wherein the de-coupling coil includes first and second de-coupling coils forming integral parts of the first and second lead-out wires, respectively.

5. The miniature transducer assembly according to claim 1, wherein the de-coupling coil has an inductance within the range 20-100 nH, or within the range 30-90 nH, or within the range 40-80 nH, or within the range 50-70 nH, or approximately 60 nH.

6-7. (canceled)

8. The miniature transducer assembly according to claim 1, wherein the de-coupling coil is a pair of de-coupling coils.

9. A wireless portable terminal comprising a miniature transducer assembly, the transducer assembly including a transducer unit comprising a voice coil for displacing a diaphragm of said transducer unit, the transducer unit further comprising a de-coupling coil for avoiding interference between the transducer unit and an antenna of said wireless portable terminal, wherein the de-coupling coil of said transducer unit is positioned inside said transducer unit, and wherein the de-coupling coil forms an integral part of a lead-out wire of the voice coil.

10. The wireless portable terminal according to claim 9, wherein the de-coupling coil is positioned below a moveable diaphragm of said transducer assembly.

11. The wireless portable terminal according to claim 9, wherein the transducer unit comprises a single voice coil and first and second lead-out wires associated therewith.

12. The wireless portable terminal according to claim 9, wherein the de-coupling coil includes first and second de-coupling coils forming integral parts of the first and second lead-out wires, respectively.

13. The wireless portable terminal according to claim 9, wherein the de-coupling coil has an inductance within the range 20-100 nH.

14. A mobile phone comprising a miniature transducer assembly including a transducer unit, the transducer unit including a voice coil for displacing a diaphragm of said transducer unit, the transducer unit further comprising a de-coupling coil for avoiding interference between the transducer unit and an antenna of said wireless portable terminal, wherein the de-coupling coil of said transducer unit is positioned inside said transducer unit, and wherein the de-coupling coil forms an integral part of a lead-out wire of the voice coil.

15. The mobile phone according to claim 14, wherein the de-coupling coil is positioned below a moveable diaphragm of said transducer assembly.

16. The mobile phone according to claim 14, wherein the transducer unit comprises a single voice coil and first and second lead-out wires associated therewith.

17. The mobile phone according to claim 14, wherein the de-coupling coil includes first and second de-coupling coils forming integral parts of the first and second lead-out wires, respectively.

18. The mobile phone according to claim 14, wherein the de-coupling coil has an inductance within the range 20-100 nH.

19. The mobile phone according to claim 14, wherein the de-coupling coil is a pair of de-coupling coils.
